(19) United States
(12) Patent Application Publication
(10) Pub. No.: US 2007/0232344 A1
(43) Pub. Date: Oct. 4, 2007

(54) DEVICE AND METHOD FOR WIRELESS RECEPTION

(76) Inventors: Tsuguhide Aoki, Kawasaki-shi (JP); Kiyoshi Toshimitsu, Tokyo (JP); Hiroshi Yoshida, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/530,713

(22) Filed: Sep. 11, 2006

(30) Foreign Application Priority Data
Sep. 13, 2005 (JP) 2005-265687

(51) Int. Cl. H04Q 7/20

(52) U.S. Cl. 455/522

(57) ABSTRACT

A wireless receiving device includes n (n is an integral number not less than 2) reception branches each capable of receiving a wireless packet containing a first signal, a second signal and a third signal in this order, the first signal including a single stream, the second signal indicating transmission of the third signal, and the third signal including a data section of a plurality of streams, a demodulation/decoding unit configured to demodulate and decode each of output signals of the reception branches, and a control unit configured to supply a power to m (m is an integral number of m<n) reception branches of the n reception branches during a receiving period of the first signal and to control power supplying to k (k is an integral number of m≦k≦n) reception branches after receiving the third signal.

### CROSS-REFERENCE TO RELATED APPLICATIONS

This application is based upon and claims the benefit of priority from prior Japanese Patent Application No. 2005-265687, field Sep. 13, 2005, the entire contents of which are incorporated herein by reference.

### BACKGROUND OF THE INVENTION

1. Field of the Invention

The present invention relates to a device and method for wireless reception used for packet communication systems such as wireless LAN.

2. Description of the Related Art

Low electric power consumption is required for wireless receiving devices used in, such as, wireless local area networks (wireless LAN). In JP-A 2000-224086 (KOKAI), there is described a technique to suppress an electric power consumption of a wireless receiving device which receives a wireless packet comprised of a preamble section and a data section succeeding the preamble section. According to JP-A 2000-224086 (KOKAI), power is supplied to only a single reception branch among the plurality of reception branches when a wireless packet is in standby mode. Power is supplied to all reception branches once the wireless packet is detected. Each reception branch includes an antenna and receiver.

The wireless receiving device supplies power to the single reception branch while its power is on and attempts to detect the wireless packet. On this occasion, by switching the switch connected to the antenna so that a received signal from each antenna is input to a single receiver, a gain from a switching diversity is obtained upon the detection of the wireless packet. The received signal is monitored, and a packet detector further carries out surveillance in order to find out whether the wireless packet is arriving. When the wireless packet is detected, antenna switching is aborted, and the all reception branches are powered on. Until the packet detector detects the end of the packet, the received signal from the antenna is output to the corresponding receiver in all reception branches, and demodulation of the wireless packet is carried out. When the packet detector detects the end of the wireless packet, the power of the reception branch is turned off, and packet detection is carried out again while switching the antennas.

As mentioned, in JP-A 2000-224086 (KOKAI), only a single reception branch is in operation during wireless packet detection, and all reception branches operate after the packet is detected. Therefore, lower power consumption can be attempted during the packet detection period, and after the packet is detected, it is possible to demodulate the received signal using all reception branches.

On the other hand, in S. A. Mujtaba et al., “TG n Sync proposal technical specification”, IEEE 802.11-04/889r3, January 2005, an example of a packet structure is proposed for IEEE 802.11n, which is the standard for the next-generation wireless LAN. The IEEE 802.11n is a standard enabling high throughput by using a multi input multi output (MIMO) technique. MIMO is a technique to demodulate data by transmitting data in parallel by using a plurality of antennas at the transmitting side and receiving such data by using a plurality of antennas at the receiving side. The wireless packet proposed by S. A. Mujtaba et al. is subjected to orthogonal frequency division multiplexing (OFDM) modulation and has a backward compatibility with IEEE 802.11a which is an existing wireless LAN standard.

In order to secure such backward compatibility, in the wireless packet proposed by S. A. Mujtaba et al., the signals of the first three fields referred to as L-STF, L-LTF and L-SIG are made in common with the wireless packet of IFF802.11a. Subsequently, the signals specific to IEEE 802.11n, referred to as HT-SIG1, HT-SIG2, HT-STF, HT-LTF1 and HT-LTF2, are arranged sequentially, and thereafter a data section is arranged. In the example of S. A. Mujtaba et al., such wireless packets are transmitted respectively from two antennas. Meanwhile, STF stands for Short Training Field, LTF for Long Training Field, and SIG for Signal Field. L—refers to Legacy, indicating IEEE 802.11a or IEEE 802.11g which is an existing wireless LAN standard. HT—stands for High Throughput, which indicates that it is a future generation wireless LAN standard-specific.

L-STF, L-LTF, L-SIG, HT-SIG1 and HT-SIG2 are signals identical between wireless packets transmitted from two antennas, but are transmitted in a cyclic delay diversity (CDD) scheme. In the CDD scheme, the signal transmitted from one of the antennas and undergone cyclic-shift sequence of the reference antenna is transmitted from the other antenna. In other words, in the CDD scheme of this case, one type of signal is transmitted from two transmitting antennas. The number of types of signals to be transmitted hereat is defined as “stream”. L-STF, L-LTF, HT-SIG and HT-SIG2 are the signals of 1 stream. On and after HT-STF, an independent signal is transmitted from each of two antennas. Here, the number of streams is 2 on and after HT-STF.

For example, when considering the case of receiving the wireless packet proposed in S. A. Mujtaba et al. by the wireless receiving device described in JP-A 2000-224086 (KOKAI), if the wireless packet is detected in the L-STF section in the lead, the plurality of branches will be powered on thereafter. The signals of L-STF, L-LTF, L-SIG, HT-SIG1 and HT-SIG2 can be demodulated sufficiently by a single reception branch. Accordingly, in consideration of reducing power consumption, it is not preferable to supply power to all reception branches even when receiving the signals of L-STF, L-LTF, L-SIG, HT-SIG1 and HT-SIG2. However, when the wireless receiving device has four or more reception branches, the power of undue number of reception branches will be turned on, causing a rise in power consumption.

Further, in wireless LAN, an environment can be assumed in which a base station or terminal receives either the wireless packet based on IEEE 802.11n or the wireless packet based on IEEE 802.11a. However, although the wireless packet based on IEEE 802.11a can be demodulated and decoded sufficiently using a single reception branch, it has a problem of increase in power consumption that the power is supplied to all reception branches even when any wireless packet is received.

### BRIEF SUMMARY OF THE INVENTION

According to the first aspect of the present invention, a wireless receiving device comprising: n (n is an integral number not less than 2) reception branches each capable of receiving a wireless packet containing a first signal, a second signal and a third signal in this order, the first signal including a single stream, the second signal indicating transmission of the third signal, and the third signal including a data section of a plurality of streams; a demodulation/decoding unit configured to demodulate and decode each of output signals of the reception branches; and a control unit configured to supply a power to m (m is an integral number of m<n) reception branches of the n reception branches during a receiving period of the first signal and to control power supplying to k (k is an integral number of m≦k≦n) reception branches after receiving the third signal.

According to the second aspect of the present invention, a wireless receiving device comprising: n (n is an integral number equal to or greater than 2) reception branches capable of receiving a first wireless packet containing a transmitting signal of a single stream and a second wireless packet containing a first signal, a second signal and a third signal in this order, the first signal including a single stream, the second signal indicating transmission of the third signal, and the third signal including a data section of a plurality of streams; a demodulation/decoding unit configured to demodulate and decode each of output signals of the reception branches; and a control unit configured to supply a power to m (m is an integral number of m<n) reception branches of the n reception branches during standby and at a time of reception of the first wireless packet and to control power supplying to k (k is an integral number of m≦k≦n) reception branches of the n reception branches after receiving the third signal of the second wireless packet.

### BRIEF DESCRIPTION OF THE SEVERAL VIEWS OF THE DRAWINGS

FIG. 1 is a block diagram of a wireless receiving device according to a first embodiment.

FIG. 2 is a flow chart showing the procedure of a reception operation in the first embodiment.

FIG. 3 is a diagram showing a wireless packet format based on IEEE 802.11n.

FIG. 4 is a diagram showing a wireless packet format based on IEEE 802.11a.

FIG. 5 is a block diagram of a wireless receiving device according to a second embodiment.

FIG. 6 is a flow chart showing the procedure of a reception operation in the second embodiment.

FIG. 7 is a table showing the combination of the number of streams and modulation scheme.

FIG. 8 is a diagram showing the relation between a reception level and frequency of errors.

FIG. 9 is a block diagram of a wireless receiving device according to a third embodiment.

FIG. 10 is a diagram showing exchanges of various sorts of wireless packets between two wireless devices for explaining the third embodiment.

FIG. 11 is a diagram showing details of each wireless packet within FIG. 10.

FIG. 12 is a flow chart showing the procedure of a reception operation in the third embodiment.

FIG. 13 is a flow chart showing the procedure of a reception operation in a fourth embodiment.

FIG. 14 is a flow chart showing the procedure of a reception operation in a fifth embodiment.

FIG. 15 is a flow chart showing the procedure of a reception operation in a sixth embodiment.

FIG. 16 is a diagram showing a relation of various wireless packets, each zone of each wireless packet and power ON/OFF operation of the reception branches in a seventh embodiment.

FIG. 17 is a flow chart showing the procedure of a reception operation in the seventh embodiment.

### DETAILED DESCRIPTION OF THE INVENTION

Embodiments of the present invention will now be described with reference to the accompanying drawings. In the following embodiments, it shall be noted that the number of reception branches required for demodulation and decoding at the receiving side is dependent on the number of types of transmitted signals. Transmitting signals of a single stream shall preferably be demodulated and decoded through a single reception branch. Transmitting signals of a plurality of streams are demodulated and decoded through a plurality of reception branches.

### First Embodiment

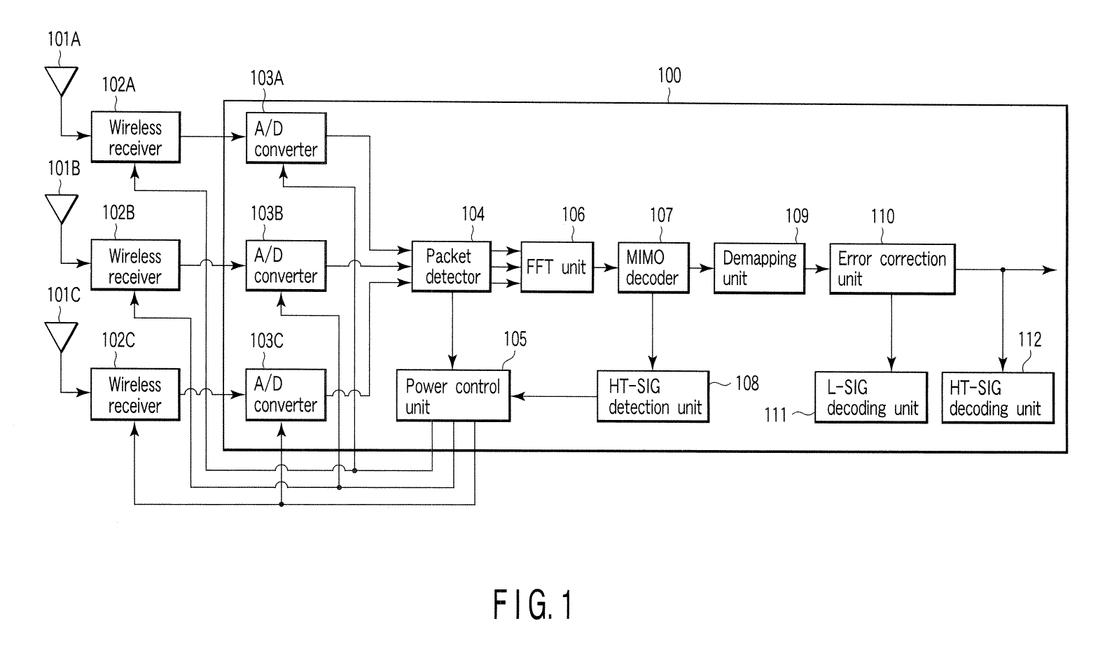

As shown in FIG. 1, a wireless receiving device according to a first embodiment of the present invention has a plurality (three, in this example) of antennas 101A to 101C, receivers 102A to 102C connected to the antennas 101A to 101C respectively and an integrated circuit unit 100 connected to the outputs of the receivers 102A to 102C. The receivers 102A to 102C include a low-noise amplifier to amplify received signals from the antennas 101A to 101C, a frequency converter (down-converter) to convert the frequency of the amplified signals to an intermediate frequency or a baseband frequency, and a variable gain amplifier for automatic gain control (AGC).

As for the integrated circuit unit 100, the output signals from the receivers 102A to 102C are converted into digital signals by analogue to digital converters (ADC) 103A to 103C, demodulation and decoding processes are carried out by a packet detector 104, fast Fourier transform (FFT) unit 106, MIMO decoder 107, an HT-SIG detection unit 108, an error correction unit 110, an L-SIG decoding unit 111 and an HT-SIG decoding unit 112.

The wireless receiving device in FIG. 1 has a plurality (three, in this example) of reception branches equal to the number of antennas 101A to 10C. The reception branches include antennas 101A to 101C, receivers 102A to 102C connected to the antennas 101A to 101C, respectively, and ADCs 103A to 103C connected to the outputs of the receivers 102A to 102C, respectively. In the integrated circuit unit 100, a power control unit 105 is further provided to control power supply to the receivers 102A to 102C and ADCs 103A to 103C of the reception branches.

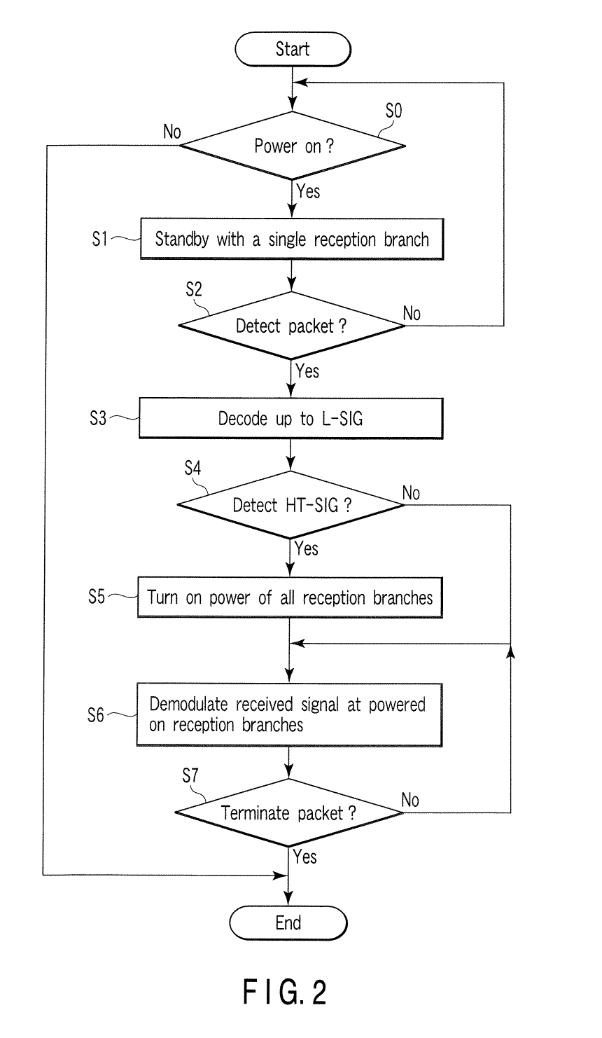

The operation of the wireless receiving device in FIG. 1 will be explained with reference to FIG. 2. At first, it is determined whether the power is supplied to the wireless receiving device or not (step S0). If the power is supplied to the receiving device, the single reception branch is put on standby mode for the wireless packet (step S1). In other words, the power control unit 105 controls the power supply for the reception branch (receiver 102A and ADC 103A) corresponding to the antenna 101A. Components other than the reception branch, i.e., the packet detector 104, power control unit 105, FFT unit 106, MIMO decoder 107, HT-SIG detection unit 108, error correction unit 110, L-SIG decoding unit 111 and HT-SIG decoding unit 112 may not be controlled by the power control unit 105, therefore, assumed to be supplied with power at all times. The OFDM-modulated signal of a wireless packet transmitted from a wireless transmitting device, which is not illustrated, is received by the antennas 101A to 101C.

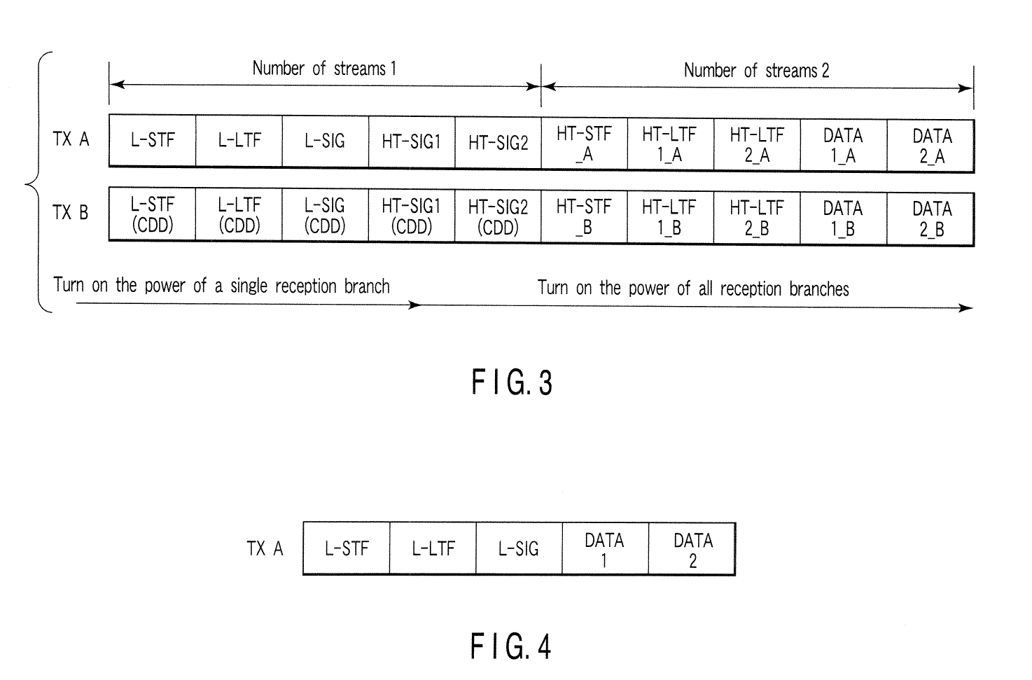

Now, a wireless packet receivable at the wireless receiving device in FIG. 1 will be explained. The wireless receiving device in FIG. 1 assumes conformity to IEEE 802.11n, which is currently drawn up as the future generation wireless LAN standard. As mentioned earlier, since the IEEE 802.11n standard has backward compatibility with the IEEE 802.11a standard, the wireless receiving device of the present embodiment assuming conformity to IEEE 802.11n can receive both the wireless packet shown in FIG. 3 and the wireless packet in the IEEE 802.11a standard shown in FIG. 4. FIG. 3 shows a wireless packet disclosed by S. A. Mujtaba et al. TX A represents a wireless packet transmitted from the A antenna of the wireless transmitting device, and TX B represents a wireless packet transmitted from the B antenna of the wireless transmitting device.

In the wireless packet according to the IEEE 802.11a standard shown in FIG. 4, L-STF, L-LTF and L-SIG are transmitted sequentially. Data sections DATA1 and DATA2 are transmitted subsequently. On the other hand, in the wireless packet according to the IEEE 802.11n standard shown in FIG. 3, in order to secure compatibility with the wireless packet in FIG. 4, L-STF, L-LTF and L-SIG are transmitted sequentially from the A antenna and the B antenna. Subsequently, HT-SIG1, HT-SIG2, HT-STF, HT-LTF1 and HT-LTF2 are transmitted, and finally, the data sections DATA1 and DATA2 are transmitted. The subscripts A and B of HT-SIG1, HT-SIG2, HT-STF, HT-LTF1, HT-LTF2, DATA1 and DATA2 indicate that they are signals respectively transmitted from the A antenna and B antenna. L-STF, L-LTF, L-SIG, HT-SIG1 and HT-SIG2 are the same type of signals, i.e., 1 stream signal, which are transmitted from the A antenna and B antenna. These signals are subjected to CDD process and the cyclic-shifted signal of A antenna is transmitted from the B antenna. In other words, L-STF, L-LTF, L-SIG, HT-SIG1 and HT-SIG2 are data common to a plurality of antennas (A and B antennas in the example of FIG. 3), but subjected to cyclic shift relatively between the A and B antennas by the CCD process. Accordingly, L-STF, L-LTF, L-SIG, HT-SIG1 and HT-SIG2 are a single type of signal, i.e., a single stream signal. In contrast, on and after HT-STF shown in FIG. 3, the two antennas transmit independent data respectively. That is, two stream signals are transmitted from the two antennas. Meanwhile, it is also possible to transmit the two stream signals by distributing them to three antennas. L-STF is used for wireless packet detection and automatic gain control (AGC) on the receiving side. L-LTF is used for estimating the channel of a wireless propagation path. L-SIG describes information on, for example, modulation scheme or encoding rate of signals (particularly, HT-SIG1 and HT-SIG2) on and after L-SIG or the combination of the modulation scheme and encoding rate (referred to as modulation and coding scheme: MCS), and packet length (the length of the entire wireless packet, or a longer length). HT-SIG1 and HT-SIG2 describe various parameters used for IEEE 802.11n, such as information indicating the number of streams of data sections DATA1 and DATA2 of the wireless packet and modulation schemes thereof. Here, such information is collectively referred to as packet attribute information.

When the wireless receiving device corresponding to IEEE 802.11n receives HT-SIG1 or HT-SIG2 in the received wireless packet, it is able to recognize that the received wireless packet possesses a wireless packet format based on IEEE 802.11n of the received packet. In other words, the HT-SIG1 and HT-SIG2 indicate that the wireless packet is MIMO-multiplexed, i.e. the data sections DATA1 and DATA2 of the wireless packet are transmitted in parallel from a plurality of antennas.

As explained in the operation of the wireless receiving device in FIG. 1, power is supplied to only the reception branch (receiver 102A and ADC 103A) corresponding to the antenna 101A in step S1. Accordingly, the received signal from the antenna 101A is subjected to a receiving process, e.g. amplification, frequency conversion (down conversion) and AGC by the receiver 102A, and then converted into a digital signal by the ADC 103A. The digital signal received from the ADC 103A is input to the packet detector 104.

The packet detector 104 detects a wireless packet by determining whether the L-STF within the wireless packet shown in, for instance, FIG. 3 and FIG. 4 is received or not (step S2), using a digital signal processing technique. The detection method for L-STF is known. For example, a method to determine that L-STF is received can be used by preparing a filter (referred to as matched filter) possessing the signal of a part of L-STF as its coefficient. If the output of this matched filter is greater or equal to the threshold value, L-STF is determined as being received.

When the wireless packet is detected by the packet detector 104, the received signal is transferred to the FFT unit 106. When the received signal is subjected to FFT by the FFT unit 106, the OFDM-modulated received signal is converted into a modulation signal for each subcarrier. The FFT unit 106 transmits its output to the MIMO decoder 107. L-STF to HT-SIG2 of the wireless packet of the received signal are receivable even by a reception branch corresponding to a single antenna. Therefore, the process of the MIMO decoder 107 is not performed in the part from L-STF to HT-SIG2. However, when the wireless receiving device is in a quite inadequate receiving environment, it is preferred that the part from L-STF to HT-SIG2 are also received by a plurality of reception branches. In such case, the MIMO decoder 107 combines the signals of a plurality of branches by a maximum ratio combining method to output a single receiving signal. As the maximum ratio combining method is a known technique, explanations thereof will be omitted.

The MIMO decoder 107 transmits its output to the HT-SIG detection unit 108 and a demapping unit 109. The demapping unit 109 converts the modulation signal into binary data of 0 and 1 for each subcarrier. The binary data is input to the error correction unit 110 to be subjected to an error correction. The error-corrected signal is decoded by the L-SIG decoding unit 111 (step S3), whereby the packet length subsequent to L-SIG and the modulation scheme or encoding rate subsequent to L-SIG, or MCS is ascertained.

Subsequently, the wireless receiving device detects HT-SIG (step S4). As mentioned earlier, since the IEEE 802.11n standard is compatible with the IEEE 802.11a standard, the wireless receiving device of the present embodiment assuming conformity to IEEE 802.11n receives either one of the wireless packets in FIG. 3 and in FIG. 4. When comparing FIG. 3 with FIG. 4, the L-STF, L-LTF and L-SIG sections are equivalent to the wireless packet of IEEE 802.11a shown in FIG. 4.

As described, since the wireless packet of FIG. 3 is identical to that of FIG. 4 up until L-SIG, the wireless receiving device is unable to distinguish whether the received wireless packet is the wireless packet of FIG. 3 or the wireless packet of FIG. 4 at the time of receiving the L-SIG. However, when the receiving device detects HT-SIG, the wireless packet can be distinguished as follows.

The HT-SIG1 in FIG. 3 and the DATA1 in FIG. 4 both are signals which are OFDM-modulated and BPSK-modulated using phase rotation of binary values of 0° and 180°. Meanwhile, the phase of the modulation signal of either or both of the HT-SIG1 and HT-SIG2 in the wireless packet of FIG. 3 is rotated 90° with respect to the modulation signal of DATA_1 based on IEEE 802.11a. Therefore, the wireless receiving device of FIG. 1 based on IEEE 802.11n detects the HT-SIG by the HT-SIG detection unit 108 by detecting the phase rotation of the signal during the period (i.e., the period immediately after receiving L-SIG) in which the HT-SIG1 and HT-SIG2 are assumed to arrive. If the phase rotation is 90°, it is determined that HT-SIG, i.e. the wireless packet of FIG. 3, is being received. On the other hand, if the phase rotation is not 90°, it is determined that the wireless packet of FIG. 4 is being received.

When a wireless packet based on IEEE 802.11n shown in FIG. 3 is arriving, a signal comprised of two streams will arrive subsequent to the HT-SIG2. In other words, as mentioned earlier, the HT-STF, HT-LTF1, HT-LTF2, DATA1 and DATA2 are independent transmission signals different from each other for each antenna. Consequently, the HT-SIG detection signal from the HT-SIG detection unit 108 is sent to the power control unit 105, which supplies a power to the reception branch (the receivers 102B and ADC 103B) corresponding to the antenna 101B and the reception branch (the receiver 102C and ADC 103C) corresponding to the antenna 101C in addition to the reception branch (the receiver 102A and ADC 103A) corresponding to the antenna 101A which has already been supplied with the power. In other words, the power control unit 105 supplies the power to all reception branches (step S5).

Meanwhile, when the wireless packet based on IEEE 802.11a shown in FIG. 4 arrives, since the wireless packet can be demodulated by the reception branch corresponding to the single antenna, only the reception branch corresponding to such single antenna powered on in step S1 is continuously kept on.

On and after HT-SIG, in either case that the wireless packet shown in FIG. 3 is received or the wireless packet shown in FIG. 4 arrives, the wireless packet is demodulated using the reception branch supplied with the power currently (step S6). The above operations are repeated until the power of the wireless receiving device is turned off in step S0, or the reception of the wireless packet is determined as completed in step S7.

In the case where the wireless packet shown in FIG. 3 arrives, the HT-SIG1 and HT-SIG2 are converted into binary data by the demapping unit 109 and are subject to error correction by the error correction unit 110. The HT-SIG decoding unit 112 recognizes a parameter peculiar to IEEE 802.11n, in particular, the number of streams of data sections DATA_1_A, B and DATA_2_A, B, modulation scheme or encoding rate, or MCS etc. written on HT-SIG1 and HT-SIG2.

During the wireless packet length shown in L-SIG, HT-SIG1 or HT-SIG2, the wireless receiving device demodulates the wireless packet in step S6. When the wireless packet shown in FIG. 3 is received, HT-STF and HT-LTF are received after HT-SIG2. Since HT-STF is used for AGC for MIMO decoding, and HT-LTF is used for channel estimation for MIMO decoding, it is preferred that the power is supplied to a plurality of reception branches. The AGC process and channel estimation for MIMO decoding are mentioned in S. A. Mujtaba et al., explanations thereof will be omitted.

Since the DATA1_A, B and DATA2_A, B received subsequently are MIMO-multiplexed, MIMO decoding process is carried out by the MIMO decoder 107. As a known technique can be used for the MIMO decoding process, explanations thereof shall be omitted.

As mentioned, in the present embodiment, for example, when receiving a wireless packet based on IEEE 802.11n, the interval of the wireless packet in which demodulation and decoding can be sufficiently performed through a single reception branch is demodulated and decoded using a single reception branch. The interval which must be demodulated and decoded through a plurality of reception branches is demodulated and decoded through a plurality of reception branches. Accordingly, the present embodiment can lower power consumption without causing performance degradation in comparison to the conventional technique whose scheme demodulates and decodes all intervals of the wireless packet through all reception branches.

Moreover, when a wireless packet based on a plurality of standards such as the IEEE 802.11a standard and the IEEE 802.11n standard arrives, only in the case where the wireless packet of an IEEE 802.11n standard requiring a plurality of reception branches arrives, demodulation and decoding are preformed through a plurality of reception branches. Accordingly, the present embodiment can lower power consumption in comparison to the conventional art which demodulates and decodes all wireless packets through the reception branches of all antennas.

In the present embodiment, L-STF, L-LTF, L-SIG, HT-SIG1 and HT-SIG2 of the wireless packet in FIG. 3 are received by a single reception branch. However, when the communication quality is significantly poor, demodulation and decoding can be performed by receiving L-STF, L-LTF, L-SIG, HT-SIG1 and HT-SIG2 by two or more reception branches instead of receiving them by a single reception branch. When demodulation and decoding data (MIMO data) on and after HT-SIG of the wireless packet of FIG. 3, MIMO data must be received with characteristics more favorable than the time of receiving L-STF, L-LTF, L-SIG, HT-SIG1 and HT-SIG2. Therefore, it is preferred that the demodulation and decoding be performed through three or more reception branches. These technical matters apply likewise to all embodiments described hereinafter.

As mentioned above, according to the present embodiment, especially when receiving the wireless packet corresponding to the IEEE 802.11n standard shown in FIG. 3, the interval of L-STF, L-LTF, L-SIG, HT-SIG1 and HT-SIG2 which can be demodulated and decoded sufficiently through a single reception branch is demodulated and decoded through a single reception branch. On the other hand, the interval (MIMO data) on and after HT-SIG are demodulated and decoded through a plurality of reception branches. Accordingly, the present invention can reduce power consumption efficiently without causing degradation in the receiving performance in comparison to the conventional art in which all intervals of the wireless packet are demodulated and decoded through all reception branches.

As mentioned, according to the present embodiment, by supplying power to only the minimum necessary number of reception branches for demodulation and decoding upon reception of each interval of a wireless packet or upon reception of a plurality of different wireless packets, low power consumption can be realized without causing degradation in its receiving performance.

### Second Embodiment

A second embodiment of the present invention will be explained. In the second embodiment, the power is supplied to all reception branches upon receiving HT-SIG1 or HT-SIG2. Subsequently, the power is not supplied to unnecessary reception branches in compliance with the number of streams among the packet attribute information written on the HT-SIG1 or HT-SIG2.

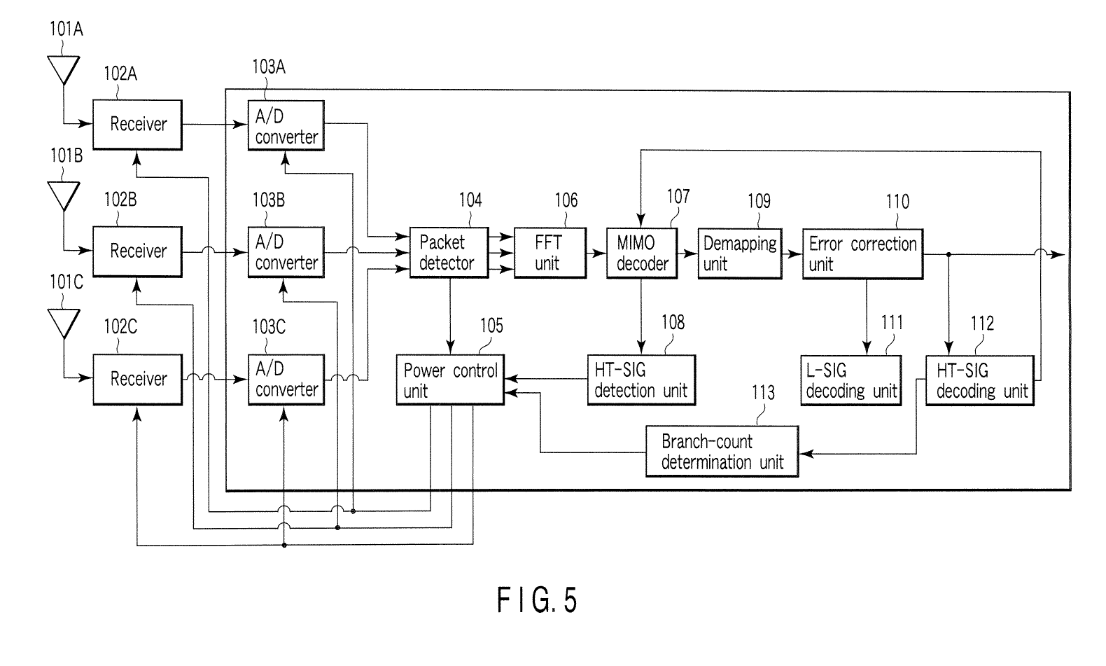

FIG. 5 shows a wireless receiving device according to the second embodiment. The second embodiment is different from the first embodiment in that the output of the HT-SIG decoding unit 112 is input to the MIMO decoder 107 and a branch-count determination unit 113 newly provided. The branch-count determination unit 113 determines the number of reception branches necessary for demodulation and decoding. The output of the branch-count determination unit 113 is input to the power control unit 105.

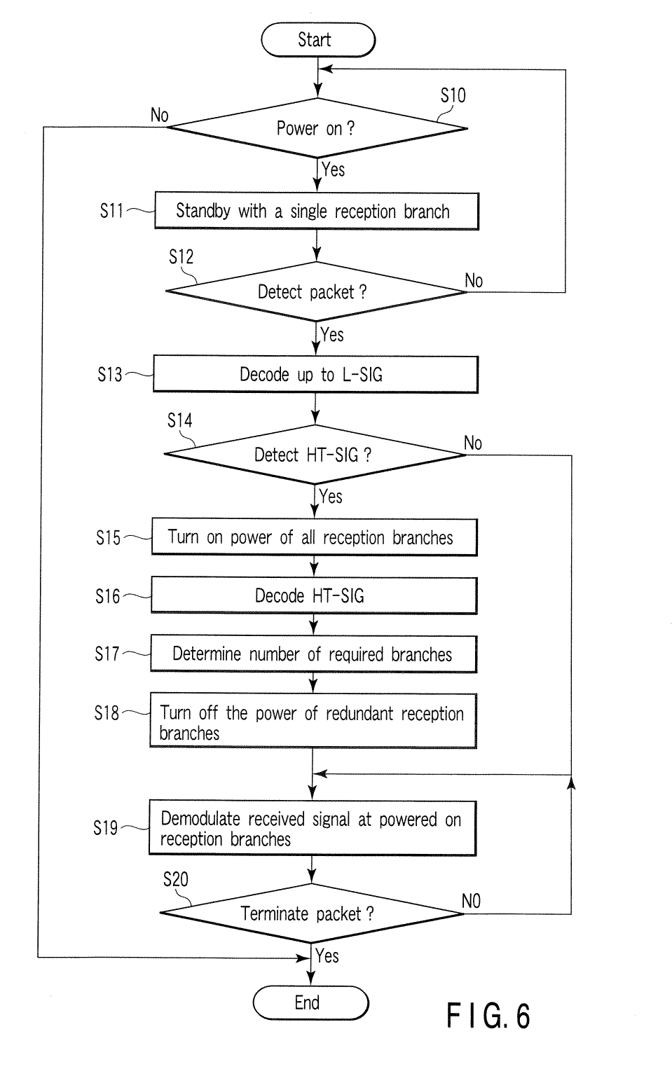

The operation of the wireless receiving device according to the second embodiment will be explained using FIG. 6. As the process from steps S11 to S15 in FIG. 6 is the same as the steps S1 to S5 in FIG. 2, explanations thereof will be omitted.

The wireless receiving device receives HT-SIG1 or HT-SIG2. When it recognizes that the wireless packet for IEEE 802.11n shown in FIG. 3 arrives, the power is supplied to all reception branches (step S15). Then, the HT-SIG1 or HT-SIG2 undergone MIMO decoding process (specifically, for example, a maximum ratio combining process) by the MIMO decoder 107 is converted into binary data by the demapping unit 109, and is subject to error correction by the error correction unit 110. The error-corrected HT-SIG1 or HT-SIG2 is input to the HT-SIG decoding unit 112.

An FFT process must be carried out for HT-SIG1 and HT-SIG2 to be decoded. Moreover, since the HT-SIG1 and HT-SIG2 have undergone error correction, an error correction is required for HT-SIG1 and HT-SIG2 to be decoded. Accordingly, the data of HT-STF should already be input to the ADC by the time the decoding result of the HT-SIG1 or HT-SIG2 is output. In the present embodiment, the power is supplied to all reception branches at this point. Accordingly, all reception branches perform AGC using HT-STF, and the input level for the ADC can be appropriately controlled.

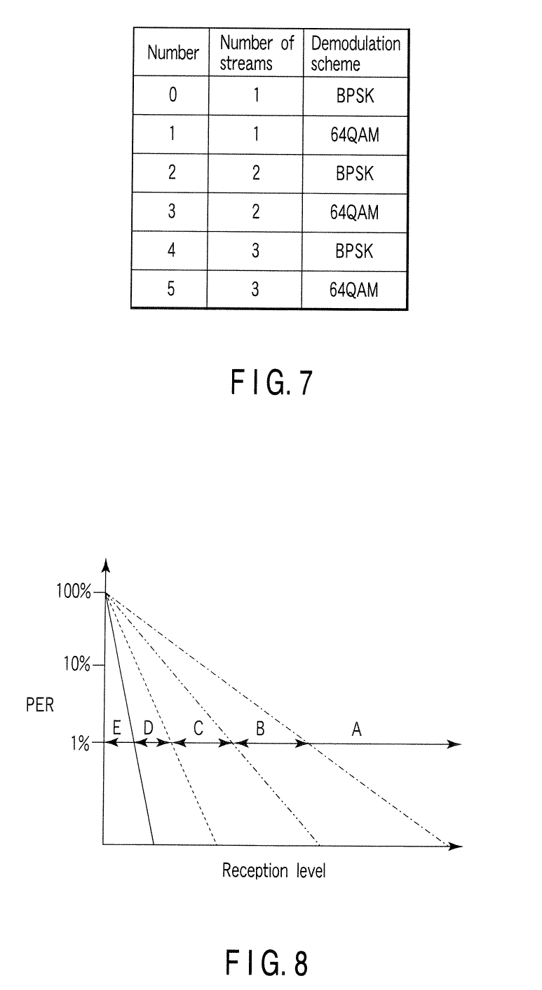

As shown in FIG. 7, there are numbers for a plurality of combinations of the number of streams and modulation schemes for DATA1_A, B and DATA2_A, B written on the HT-SIG1 or HT-SIG2. The wireless reception unit decodes the HT-SIG1 or HT-SIG2 by the HT-SIG decoding unit 112 (step S16). As a result, from the numbers written on the HT-SIG1 or HT-SIG2, the number of streams and modulation schemes can be recognized.

FIG. 8 is a diagram showing a packet error rate (PER) with respect to a reception level when demodulating a received signal in which the number of streams is two. In FIG. 8, the solid line shows characteristic features in the case of using four antennas for reception. Similarly, the dotted line, the chain double-dashed line and the chain line each show characteristic features in the case of using three antennas, two antennas, and one antenna, respectively. For instance, if the receiving performance can be satisfied with only 1% of PER, the reception level can be divided into the five domains of A, B, C, D and E as shown in FIG. 8 with respect to the number of antennas used for reception. Region A can achieve PER=1% using only one antenna upon reception, and region B can satisfy PER=1% using two or more antennas upon reception. Similarly, region C can satisfy PER=1% using three or more antennas upon reception, domain D can satisfy PER=1% using four or more antennas upon reception, whereas domain E cannot satisfy PER=1% despite using four antennas upon reception.

Here, when the reception level is in the domain B in the case where the number of streams written on the HT-SIG is two, it will overrun the designed specification to perform demodulation by supplying the power to all reception branches (three branches in the embodiment), which exceed the number of streams. With that, in reference to FIG. 8, the branch-count determination unit 113 determines that two reception branches are required in this case (step S17). Then, the branch-count determination unit 113 commands the power control unit 105 to keep the power for only two reception branches and to turn off the power for the other reception branches. Based on the command, the power control unit 105 cuts off the power to one remaining unnecessary reception branch (step S18).

The MIMO decoder 107 then receives information indicating which reception branch is in a power-off state and performs MIMO decoding for only the output of the reception branch in a power-on state (step S19). In other words, MIMO decoding is performed for two reception branches. The above operations are repeated until it is determined that the power of the wireless receiving device is turned off in step S10 or the reception of the wireless packet has terminated in step S20.

As mentioned above, according to the second embodiment, the modulation of the wireless packet is carried out always with the power of the minimal number of reception branches turned on in accordance with the number of streams of the received wireless packets. Accordingly, lower power consumption can be realized without degradation in receiving performance.

Furthermore, in the present embodiment, the power is supplied to all reception branches in step S15 at which time the reception of HT-SIG is detected in step S14. AGC is performed on all reception branches by using HT-STF. Here, in the case of supplying the power to the number of reception branches required for reception after decoding HT-SIG, the reception branch supplied with the power newly will not be able to complete the AGC process. Accordingly, the newly power-supplied reception branches will not be able to carry out appropriate A/D conversion. Therefore, significant degradation in the receiving performance may occur due to, for example, quantization error or saturated output of the ADC.

However, in the present embodiment, HT-SIG is decoded in step S16 after performing AGC with all of the reception branches supplied with the power. The number of reception branches necessary for reception is determined in step S17, and the power of the reception branches unnecessary for reception is cut off. Accordingly, since all reception branches have been A/D-converted appropriately by the time of demodulating the received signals (at the time of MIMO decoding), demodulation can be realized with high accuracy.

As explained earlier in FIG. 7, the numbers for a plurality of combinations of the number of streams and modulation schemes for DATA1_A, B and DATA2_A, B are written on the HT-SIG1 or HT-SIG2. However, an encoding rate can be used instead of the modulation scheme, or the modulation scheme and encoding rate, i.e. MCS, may also be used. Alternatively, since a packet for such as a wireless LAN is provided with an error detecting function in the data section, it is also fine to determine the number of reception branches by using this. In other words, if a large number of packet errors are detected when continuing with reception by the current reception branch, the number of reception branches can be increased. If the number of error detections is small, the number of reception branches can be reduced.

In FIG. 8, the reception level represents the horizontal axis. However, this can be replaced by a received power to noise power density ratio whereby the number of reception branches can be controlled with higher accuracy. The received power to noise power density ratio can be estimated using somewhat known information on the receiving side, such as L-SIG and HT-SIG in the wireless packet of FIG. 3.

### Third Embodiment

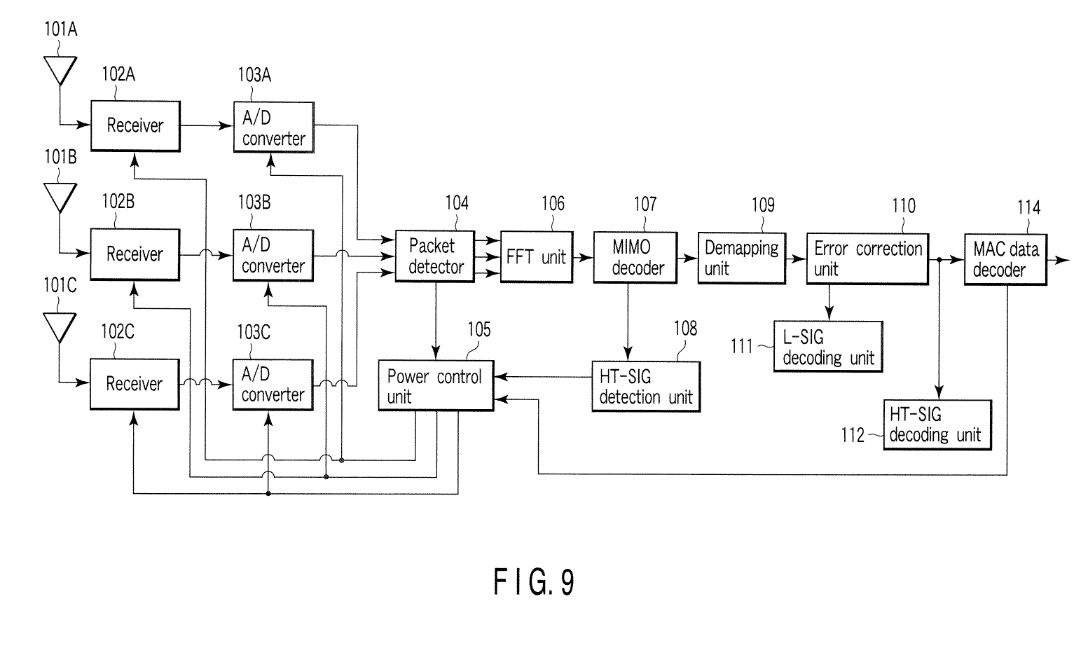

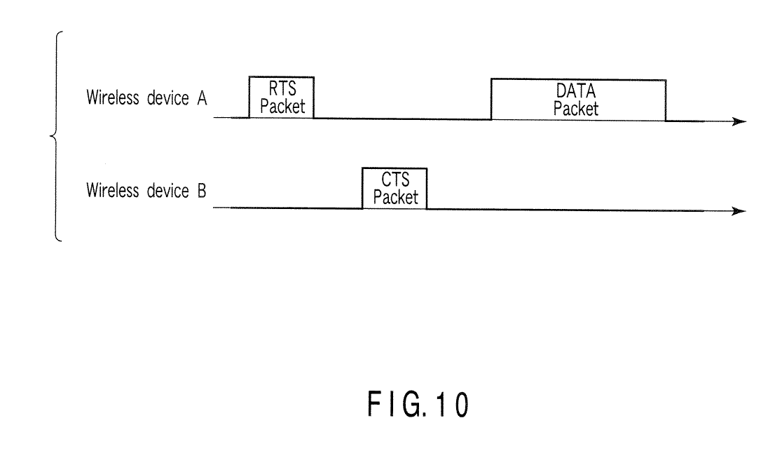

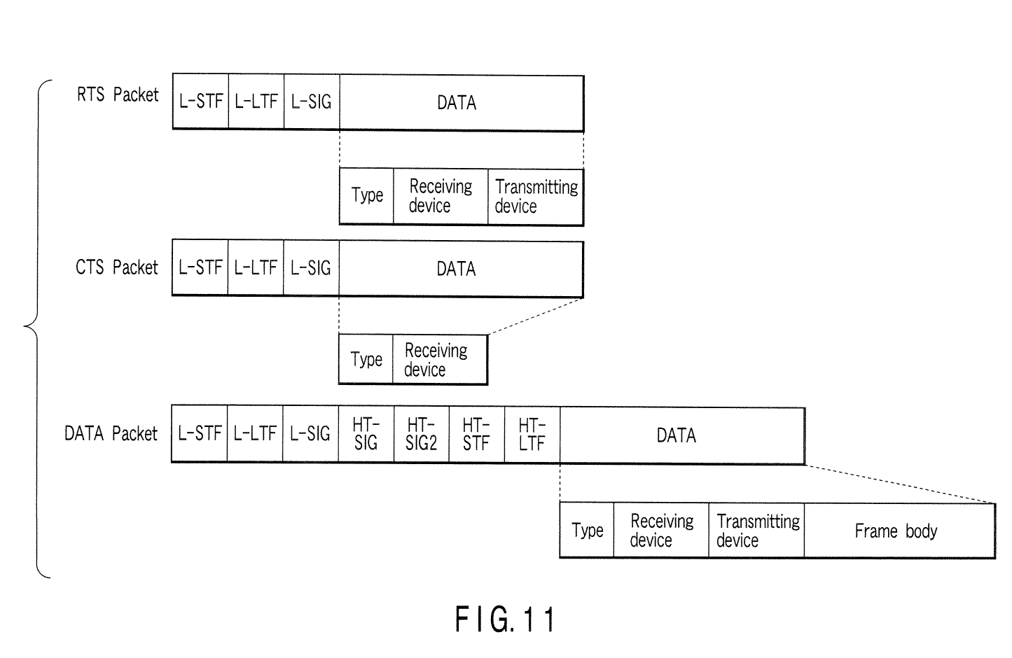

FIG. 9 is a wireless receiving device according to a third embodiment of the present invention, wherein an MAC data decoder 114 is added to the wireless receiving device shown in FIG. 1. A command can also be given to the power control unit 105 by this MAC data decoder 114. FIG. 10 shows exchanges of various types of wireless packets. FIG. 11 shows the content of each wireless packet shown in FIG. 10.

The present embodiment will be explained in detail with reference to FIGS. 9 to 11 as follows. When a DATA packet is transmitted from a wireless device A to a wireless device B as in FIG. 10, the wireless device A may transmit a wireless packet called RTS (request to send) in advance, in order to give notice to the wireless device B and neighboring wireless devices of the transmission. The structure of the RTS packet is shown in the top portion of FIG. 11, and has the same structure as the wireless packet shown in FIG. 4 with respect to L-STF to L-SIG. The content of the RTS packet data section DATA includes a “type” field which indicates the type of packet (in this case, a value indicating an RTS packet is written), “address of receiving device” which indicates the receiving device to receive the RTS packet, and “address of transmitting device” which indicates the transmitting device to transmit the RTS packet. In this example, it is considered that a DATA packet is transmitted from the wireless device A to the wireless device B. Therefore, the address of the wireless device B is written in the “address of receiving device”, and the address of the wireless device A is written in the “address of transmitting device”.

The wireless device B which has received the RTS packet demodulates the RTS packet using the wireless receiving device shown in FIG. 9. The process carried out prior to the MAC data decoder 114 is the same as explained in the first and second embodiments. Therefore, explanations thereof will be omitted. Data error-corrected by the error correction unit 110 is input to the MAC data decoder 114, which reads out the type of the wireless packet in a predetermined sequence. For instance, by reading the “type” field, the received wireless packet will prove to be an RTS packet. Therefore, the wireless device B then reads out the “address of receiving device” and the “address of transmitting device”. Here, if the “address of receiving device” is the wireless device B, i.e. it is addressed to the wireless device B itself, the wireless device B must transmit a CTS (clear to send) packet subsequently. The content of the CTS packet is as shown in the middle portion of FIG. 11. The data section DATA includes a “type” field which indicates the type of wireless packet and an “address of receiving device”.

The wireless device B transmits the CTS packet in a predetermined sequence. As this sequence is mentioned in the wireless standard IEEE 802.11a, the CTS packet also has the same structure as the wireless packet shown in FIG. 4 with respect to L-STF to L-SIG.

Having received the CTS packet, the wireless device A then transmits a DATA packet to the wireless device B. The DATA packet has a structure shown in the lower portion of FIG. 11 and is transmitted in the wireless packet format for IEEE 802.11n shown in FIG. 3. In other words, the data section DATA of the DATA packet is MIMO-multiplexed and then transmitted. The data section DATA of the DATA packet includes a “type” field indicating that it is a DATA packet in which the wireless packet carries data, an “address of receiving device” indicating the receiving device to receive the DATA packet, an “address of transmitting device” indicating the transmitting device for transmitting the DATA packet, and a “frame body” which is the actual transmit data.

As described above, by exchanging RTS and CTS between the wireless device A which transmits the DATA packet and the wireless device B which receives the DATA packet, the wireless device B will be able to know in advance whether it will receive a wireless packet addressed to itself or to others. In the case where the wireless device B receives an RTS packet which is not addressed to itself, the data section DATA of the data packet received subsequent to the CTS packet does not have to be demodulated even if it is an IEEE 802.11n packet. Accordingly, when the wireless device B receives an RTS packet whose “address of receiving device” is not addressed to the wireless device B itself, the MAC data decoder 114 sends out commands not to supply the power to all reception branches for the DATA packet to be received next, even if an HT-SIG is detected.

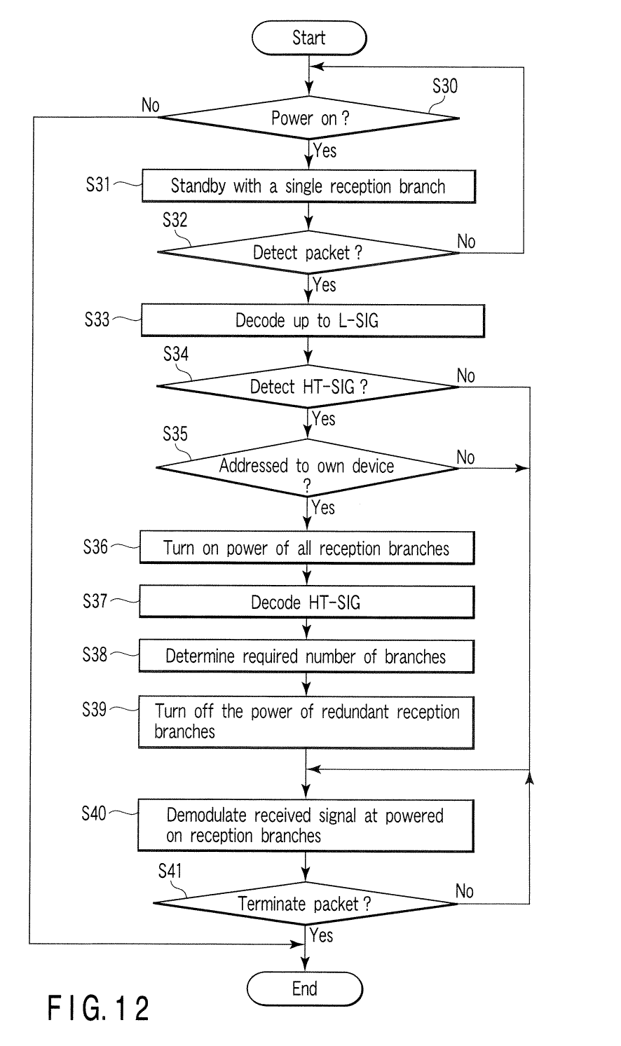

The process of the present embodiment will be explained in detail with reference to FIG. 12. The process of steps S31 to S34 is the same as that of the first and second embodiments. Therefore, explanations thereof will be omitted. When it is determined that HT-SIG is detected in step S34, the wireless receiving device determines whether the received wireless packet is addressed to itself or not by exchanging the RTS packet and CTS packet explained in FIGS. 10 and 11 (step S35). Here, if the received wireless packet is addressed to itself, the process moves on to step S36 where the power is supplied to all reception branches. On the other hand, if the received wireless packet is not addressed to the wireless receiving device itself, reception proceeds by only the single reception branch. The process of the subsequent steps S37 to S41 is the same as the procedure in FIG. 6 of the second embodiment. Therefore, explanations will be omitted.

According to the present embodiment, when a wireless packet addressed to other devices, which does not need to be MIMO decoded, is received, only a single reception branch is supplied with the power, and the power is not supplied to the other unnecessary reception branches. With this, lower power consumption can be realized without causing degradation in the receiving performance.

The present embodiment carries out reception by a single reception branch in the case where the arriving wireless packet is not addressed to itself. However, in fact, there shall be no problem with the wireless protocol even if the reception is entirely aborted. Accordingly, it is also fine not to supply the power to all reception branches and cease the receiving operation entirely in the case where the arriving wireless packet is not addressed to itself. Consequently, power consumption can be further reduced.

### Fourth Embodiment

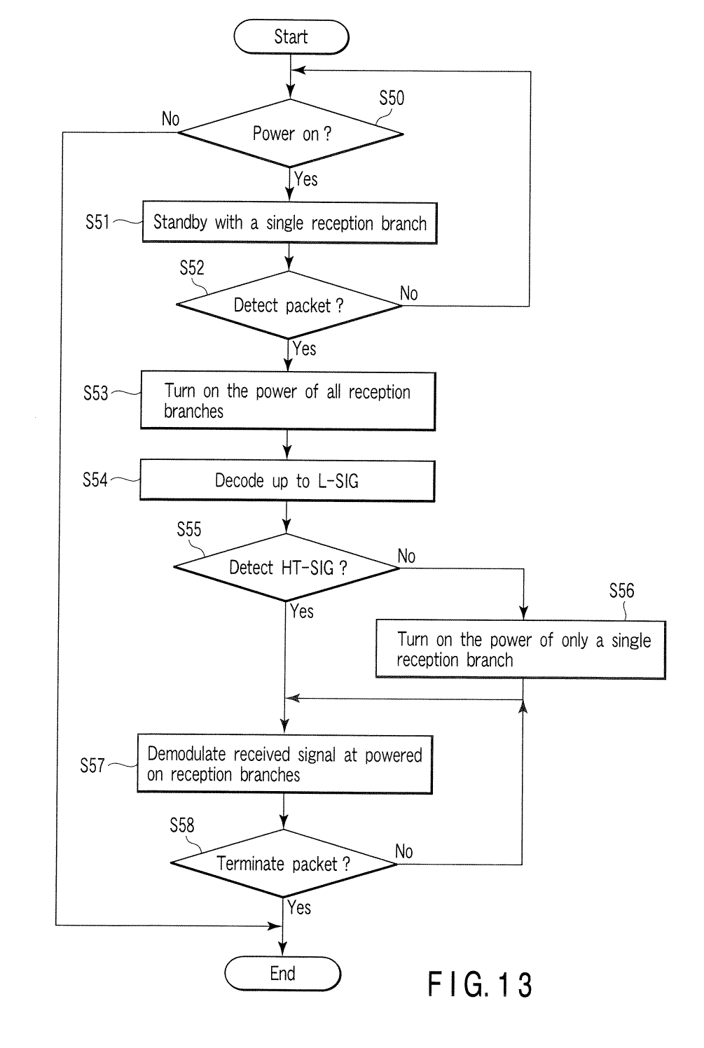

A fourth embodiment of the present invention will be explained. The present embodiment is a modified version of the first embodiment, however, is different in that it supplies the power to all reception branches immediately after performing the wireless packet detection. In explanation of the processing sequence of the fourth embodiment using FIG. 13, the wireless receiving device performs a standby mode by a single reception branch at the time of standby, like the first to third embodiments (S50-S51).

When a wireless packet is detected in step S52, the power is supplied to all reception branches and decoding is performed up to L-SIG (step S53-S54). Then, when HT-SIG is detected in step S55, decoding is performed on end with the power of all reception branches kept on. On the other hand, when HT-SIG is not detected in step S55, the process moves on to step S56 where only the single reception branch is powered on while the other reception branches are turned off, and subsequent packets are demodulated (step S57). The above operation is repeated until the power to the wireless receiving device is cut off in step S50, or it is determined that the reception of the wireless packet has terminated in step S58.

As explained above, according to the present embodiment, in addition to the advantages of the first embodiment, there is an advantage of being able to demodulate L-SIG and HT-SIG with further precision by demodulating L-SIG and HT-SIG using a plurality of reception branches. Accordingly, control error will no longer occur and receiving characteristics can be improved.

### Fifth Embodiment

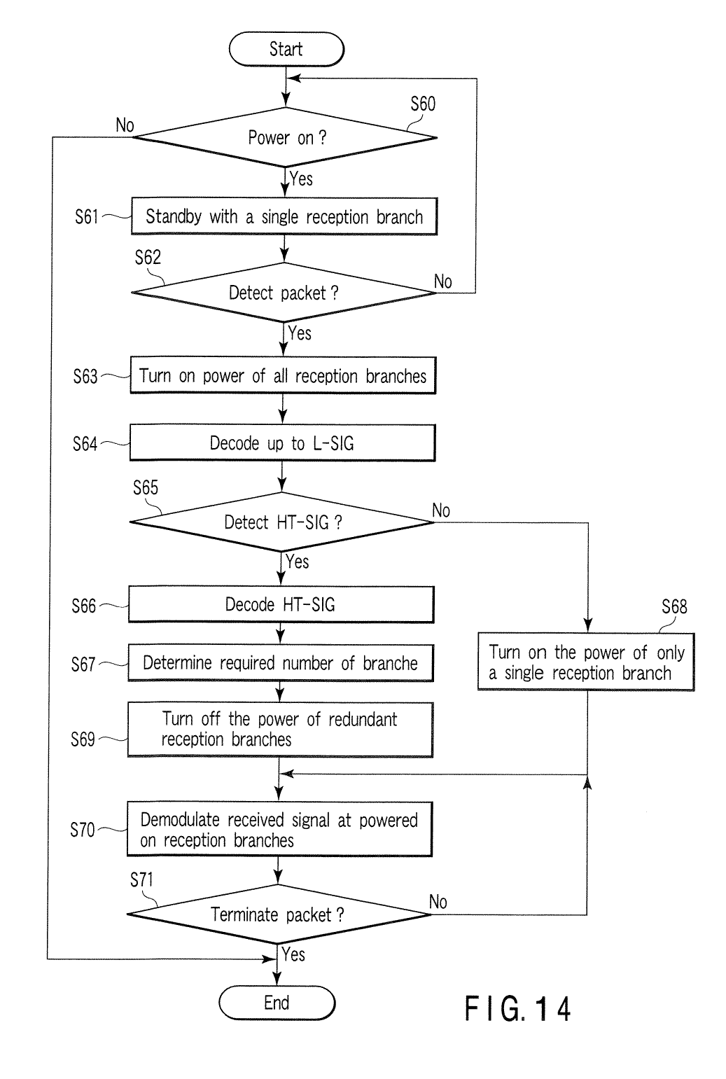

A fifth embodiment of the present invention will be explained. The present embodiment is a modified version of the second embodiment, and is different from the second embodiment in that all reception branches are supplied with a power immediately after the wireless packet detection is carried out. In explanation of the processing sequence of the fifth embodiment using FIG. 14, the present embodiment performs standby using a single reception branch like the first to fourth embodiments (step S60-S61). Subsequently, when a wireless packet is detected in step S62, the power of all reception branches are turned on and decoding is performed up to L-SIG (step S63-64). Then, when HT-SIG is detected in step S65, HT-SIG is decoded (step S66) and the required number of branches is determined (step S67). On the other hand, in the case where HT-SIG is not detected in step S65, only the single reception branch is powered on while the other reception branches are turned off (step S68), and subsequent packets are demodulated (step S69). The above operation is repeated until the power of the wireless receiving device is turned off in step S71, or it is determined that the reception of the wireless packet has terminated in step S60.

As explained above, according to the fifth embodiment, in addition to the advantages of the second embodiment, there is an advantage of being able to demodulate L-SIG and HT-SIG with further precision by demodulating L-SIG and HT-SIG using a plurality of reception branches likewise the fourth embodiment. Further, in the present embodiment, control can be carried out with higher accuracy, since it is possible to measure the reception level or the signal power to noise power density rate using a plurality of antennas when determining the number of reception branches using a table such as in FIG. 10.

### Sixth Embodiment

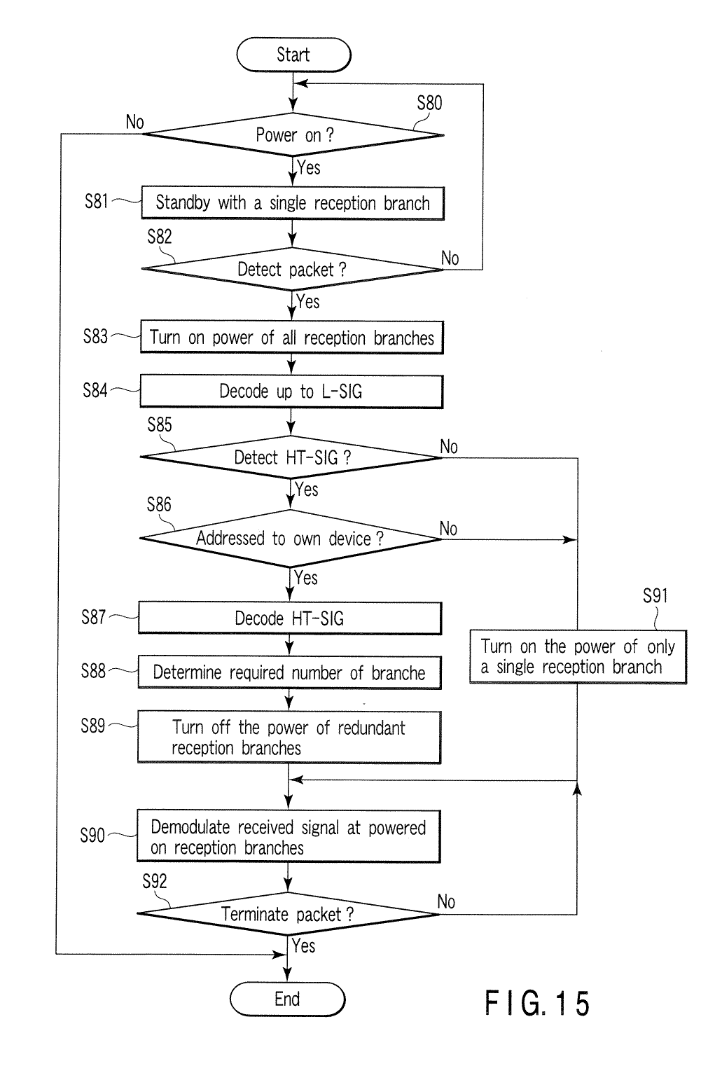

A sixth embodiment of the present invention will be explained. The present embodiment is a modified version of the third embodiment, and is different from the third embodiment in that all reception branches are supplied with the power immediately after the wireless packet detection is carried out. In explanation of the processing sequence of the sixth embodiment using FIG. 15, the present embodiment performs standby using a single reception branch like the first to fifth embodiments (step S80-S81). Subsequently, when a wireless packet is detected in step S82, the power is supplied to all reception branches, and decoding is performed up to L-SIG (step S83-84).

When HT-SIG is detected in step S85, the wireless receiving device determines whether the received wireless packet is addressed to itself or not by exchanging the RTS packet and CTS packet explained in FIGS. 10 and 11 (step S86). Here, if the received wireless packet is addressed to the wireless receiving device itself, the required number of reception branches is determined by decoding the HT-SIG (step S88). The power of redundant reception branches is cut off (step S89), and subsequent packets are demodulated (step S90).

On the other hand, if HT-SIG is not detected in the step S85, or if the wireless packet received in step S86 is not addressed to the wireless receiving device itself, only the power of the single reception branch remains on (step S91), and demodulation is carried out on subsequent packets (step S90). The above operation is repeated until the wireless receiving device is powered off, or it is determined that the reception of the wireless packet has terminated in step S92.

As explained above, according to the sixth embodiment, in addition to the same advantages of the third embodiment, there is an advantage of being able to demodulate L-SIG and HT-SIG with further precision by demodulating L-SIG and HT-SIG using a plurality of reception branches like the fourth and fifth embodiments. Further, in the present embodiment, control can be carried out with higher accuracy, since it is possible to measure the receiving power or the signal power to noise power density rate using a plurality of antennas when determining the number of reception branches using a table such as in FIG. 10.

Like the third embodiment, in the present embodiment, when the arriving wireless packet is not addressed to the wireless receiving device itself, there shall be no problem for the wireless protocol in particular to cut off the power to all reception branches and cease the receiving operation completely. With that, further reduced power consumption can be attempted.

### Seventh Embodiment

A seventh embodiment of the present invention will be explained. The present embodiment is different from the first to sixth embodiments in that it provides a wireless receiving device which can lower power consumption even in the case where an IEEE 802.11n exclusive packet incompatible with IEEE 802.11a is arriving in addition to the IEEE 802.11a packet and the IEEE 802.11n packet compatible with IEEE 802.11a.

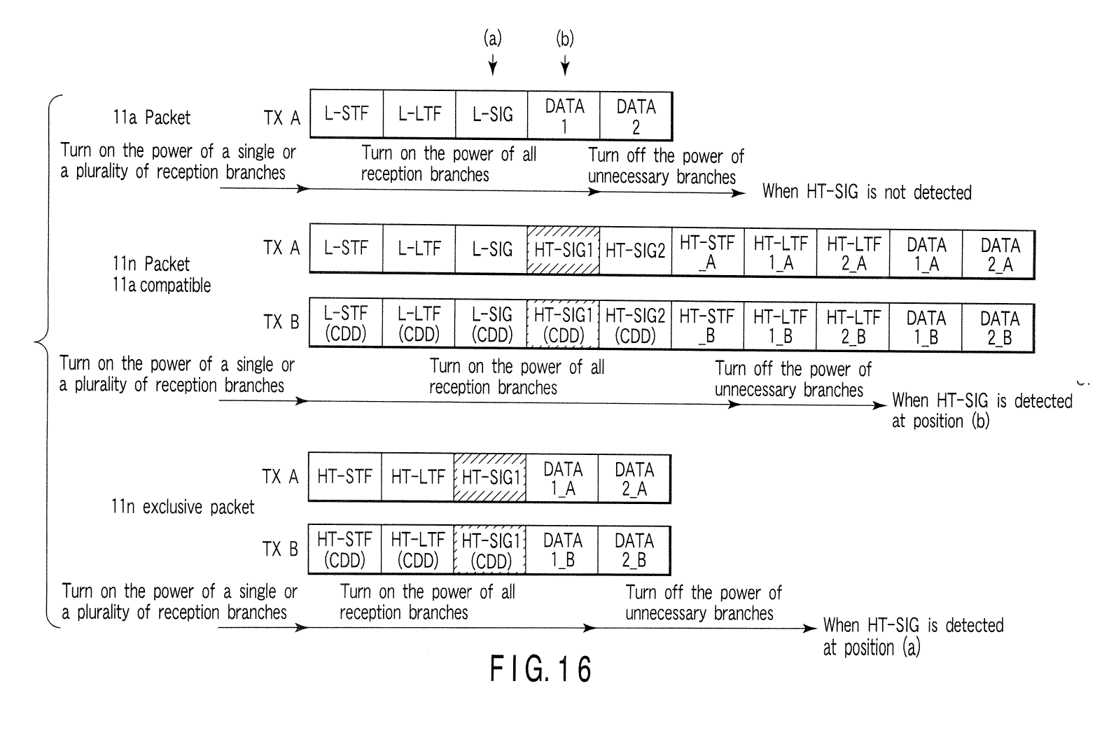

The following will be explained using FIG. 16. The “11a packet” shown in the top portion of FIG. 16 is the same as that of FIG. 4, and the “11n packet (compatible with 11a)” is the same as that of FIG. 3. Accordingly, explanations on the “11a packet” and the “11n packet (compatible with 11a)” will be omitted.

The “11n exclusive packet” described in the lower portion of FIG. 16 is an IEEE 802.11n exclusive wireless packet which is incompatible with IEEE 802.11a, and comprises HT-STF, HT-LTF, HT-SIG1 and DATA. Like the HT-SIG1 of the 11n packet, the HT-SIG is configured to automatically detect the HT-SIG1 by the receiving side. As this has been explained in the first embodiment, explanations thereof will be omitted.

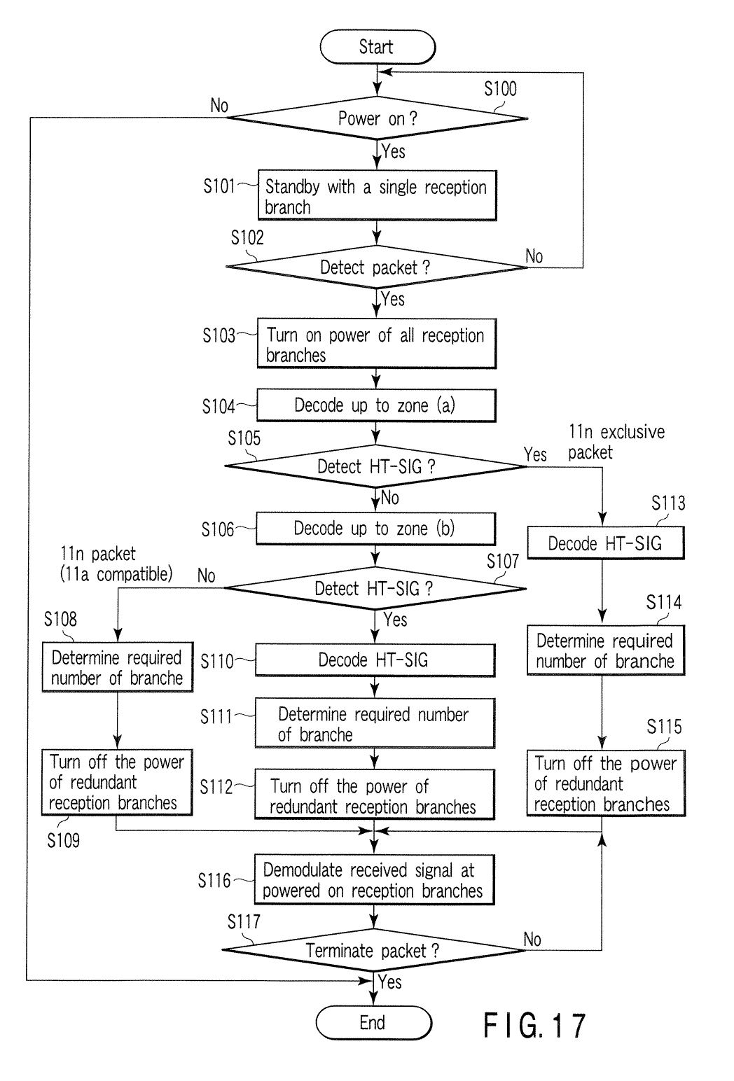

In explanation of the processing sequence of the seventh embodiment using FIG. 17, like the third to sixth embodiments, the present embodiment uses a single reception branch or antennas less than the number of the transmitting and receiving antennas at the time of standby (step S100-S101). When a wireless packet is detected, the power is supplied to all reception branches (step S102-103), and AGC is performed by all of the reception branches.

Then, the symbol of position (a) in FIG. 16 is decoded (step S104). If HT-SIG is detected at this point, the arriving wireless packet is determined by FIG. 16 as the IEEE 802.11n exclusive packet which is incompatible with IEEE 802.11a. In such case, HT-SIG is decoded (step S113), and the number of streams, modulation scheme or encoding rate of IEEE 802.11n exclusive packet is obtained. Then, as explained in the second embodiment, the number of reception branches required for demodulation is determined from the number of streams, modulation scheme or encoding rate of the IEEE 802.11n exclusive packet, and the signal power, the signal power to noise power density ratio or the delay spread of the propagation path (step S114). When the number of receiving antennas required for demodulation is detected, the power of redundant reception branches is turned off (step S115). Subsequently, the received signals are demodulated using the reception branches supplied with power (step S116).

Meanwhile, when HT-SIG is not detected in step S105, the wireless receiving device continues to demodulate the symbol of position (b) in FIG. 16 (step S106). When HT-SIG is detected in position (b) (step S107), it is determined by FIG. 16 that the arriving wireless packet is a packet of IEEE 802.11n which is compatible with IEEE 802.11a. Accordingly, HT-SIG is decoded subsequently (step S110), and the number of streams, modulation scheme or encoding rate of the arrival packet is obtained. As explained in the second embodiment, since HT-STF arrives subsequent to HT-SIG, HT-STF is used for performing AGC using all reception branches.

Then, as explained in the second embodiment, the number of reception branches required for demodulation is determined from the number of streams, modulation scheme or encoding rate of the packet, and the signal power, the signal power to noise power density ratio or the delay spread of the propagation path (step S111). When the number of reception branches required for demodulation is determined, the power of redundant reception branches is turned off (step S112). The received signals are demodulated by the reception branches supplied with power subsequently (step S116).

When HT-SIG is not detected in step S107, it is determined by FIG. 16 that the arrival wireless packet is IEEE 802.11a. Since the modulation scheme and encoding rate of the packet of IEEE 802.11a is already notified by L-SIG, the number of reception branches required for demodulation is determined from the modulation scheme or encoding rate of the packet, and the signal power, signal power to noise power density ratio or the delay spread of the propagation path, and so on (step S108). When the number of reception branches required for demodulation is determined, the power of redundant reception branches is cut off (step S112). Subsequently, the received signals are demodulated by the reception branches supplied with power (step S116).

As mentioned, according to the present embodiment, even when any one of the IEEE 802.11n exclusive packet, the IEEE 802.11n packet compatible with IEEE 802.11a, and IEEE 802.11a packet arrives, the number of reception branches can be reduced without causing performance degradation and without mistaking one packet from the other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless receiving device comprising:
n (n is an integral number not less than 2) reception branches each capable of receiving a wireless packet containing a first signal, a second signal and a third signal in this order, the first signal including a single stream, the second signal indicating transmission of the third signal, and the third signal including a data section of a plurality of streams;
a demodulation/decoding unit configured to demodulate and decode each of output signals of the reception branches; and
a control unit configured to control power supplying to m (m is an integral number of m<n) reception branches of the n reception branches during a receiving period of the first signal and to control power supplying to k (k is an integral number of m≦k≦n) reception branches after receiving the third signal.

2. The device according to claim 1, wherein the second signal includes the number of the plurality of streams and packet attribute information indicating at least one of a modulation scheme and an encoding rate of the data section, and the control unit controls power supplying to the n reception branches once after receiving the second signal and continues to control power supplying to the k reception branches determined according to the packet attribute information, or the packet attribute information and receiving characteristics, after detecting the packet attribute information.

3. The device according to claim 2, wherein the power control unit uses at least one of a reception level of each of the reception branches, a receiving power to noise power density ratio and a delay spread of a propagation path as the receiving characteristics.

4. The device according to claim 1, further comprising an address determination unit configured to determine whether the wireless packet is addressed to the wireless receiving device or to another wireless receiving device, wherein the power control unit continues to control power supplying to the m reception branches even after receiving the third signal if the address determination unit determines the wireless packet as addressed to another receiving device.

5. The device according to claim 1, further comprising an address determination unit configured to determine whether the wireless packet is addressed to the wireless receiving device or to another wireless receiving device, wherein the power control unit turns off the power supply of the n reception branches after receiving the second signal if the address determination unit determines the wireless packet as addressed to the other wireless receiving devices.

6. A wireless receiving device comprising:
n (n is an integral number equal to or greater than 2) reception branches capable of receiving a first wireless packet containing a transmitting signal of a single stream and a second wireless packet containing a first signal, a second signal and a third signal in this order, the first signal including a single stream, the second signal indicating transmission of the third signal, and the third signal including a data section of a plurality of streams;
a demodulation/decoding unit configured to demodulate and decode each of output signals of the reception branches; and
a control unit configured to control power supplying to m (m is an integral number of m<n) reception branches of the n reception branches during standby and at a time of reception of the first wireless packet and to control power supplying to k (k is an integral number of m≦k≦n) reception branches of the n reception branches after receiving the third signal of the second wireless packet.

7. The device according to claim 6, wherein the second signal includes the number of the plurality of streams and packet attribute information indicating at least one of the modulation scheme and an encoding rate of the data section, and the power control unit controls power supplying to the n reception branches once after recognizing reception of the second wireless packet by reception of the second signal and continues to control power supplying to the k reception branches determined according to the packet attribute information, or the packet attribute information and receiving characteristics, after detecting the packet attribute information.

8. The device according to claim 6, further comprising an address determination unit to determine whether the wireless packet is addressed to the wireless receiving device or to another wireless receiving device, wherein the power control unit continues to control power supplying to the m reception branches even after receiving the third signal if the address determination unit determines the wireless packet as addressed to the another receiving device.

9. The device according to claim 7, further comprising an address determination unit configured to determine whether the wireless packet is addressed to the wireless receiving device or to another wireless receiving device, wherein the power control unit turns off the power supply of the n reception branches after receiving the third signal if the address determination unit determines the wireless packet as addressed to the another wireless receiving device.

10. The device according to claim 6, wherein the power control unit uses at least one of a reception level of the reception branch, a receiving power to noise power density ratio and a delay spread of a propagation path as the receiving characteristics.

11. A wireless reception method comprising:
receiving a wireless packet containing a first signal, a second signal and a third signal in this order, the first signal including a single stream, the second signal indicating transmission of the third signal, and the third signal including a data section of a plurality of streams, by each of n (n is equal to or greater than 2) reception branches;
demodulating and decoding each of output signals of the reception branches;
controlling power supplying to m (m is an integral number of m<n) reception branches of the n reception branches during a reception period of the first signal; and
controlling power supplying to k (k is an integral number m≦k≦n) reception branches of the n reception branches after receiving the third signal.

12. The method according to claim 11, wherein the second signal includes the number of the plurality of streams and packet attribute information indicating at least one of a modulation scheme and an encoding rate of the data section, and the controlling power supplying to k reception branches controls power supplying to the n reception branches once after receiving the second signal and continues to control power supplying to k reception branches determined according to the packet attribute information, or the packet attribute information and receiving characteristics, after detecting the packet attribute information.

13. A wireless reception method comprising:
receiving a first wireless packet containing a transmitting signal of a single stream and a second wireless packet containing a first signal, a second signal and a third signal in this order, the first signal including a single stream, the second signal indicating transmission of the third signal, and the third signal including a data section of a plurality of streams, by n (n is equal to or greater than 2) reception branches;
demodulating and decoding each of output signals of the reception branches;
controlling power supplying to m (m is an integral number of m<n) reception branches during standby and at a time of reception of the first wireless packet; and
controlling power supplying to k (k is an integral number of m≦k≦n) reception branches of the n reception branches after receiving the third signal of the second wireless packet.

14. The method according to claim 13, wherein the second signal includes the number of the plurality of streams and packet attribute information indicating at least one of the modulation scheme and an encoding rate of the data section, and the controlling power supplying to k reception branches controls power supplying to the n reception branches once after recognizing reception of the second wireless packet by reception of the second signal and continues to control power supplying to the k reception branches determined according to the packet attribute information, or the packet attribute information and receiving characteristics, after detecting the packet attribute information.
